(19) United States
(12) Patent Application Publication
(10) Pub. No.: US 2008/0105708 A1
(43) Pub. Date: May 8, 2008

(54) Fluid supply container and fuel cell system using the same

(75) Inventors: Makoto Ebikawa, Sagamihara-shi (JP); Toru Takahashi, Sagamihara-shi (JP); Junji Oyama, Sagamihara-shi (JP); Nobuo Katsuura, Sagamihara-shi (JP)

Correspondence Address: NIXON PEABODY, LLP, 401 9TH STREET, NW, SUITE 900, WASHINGTON, DC, 20004-2128, US

(73) Assignee: NIX, Inc., Yokohama-shi (JP)

(21) Appl. No.: 11/592,965

(22) Filed: Nov. 6, 2006

(51) Int. Cl. B67D 5/60

(52) U.S. Cl. 222/145.1; 222/386.5; 222/339; 222/386.5

(57) ABSTRACT

A fluid supply container that can continuously apply pressure to a fluid stored therein and enhance the supply rate of the fluid to a liquid acceptor is provided. Also, a fuel cell system including the fluid supply container is provided.

A fluid supply container 1 includes a fluid storage unit 20 and a pressurizing mechanism 30 for pressurizing the fluid storage unit 20 and supplies a fluid stored in the fluid storage unit 20 to a fluid acceptor. The fluid storage unit 20 includes a first storage chamber 21 and a second storage chamber 22 defined by a flexible member 23 and connected to the first storage chamber 21 so as to allow the fluid to flow to/from the first storage chamber 21. The flexible member 23 is reversed by means of pressurization by the pressurizing mechanism 30 so that the flexible member 23 enters the first storage chamber 21, thereby reducing the volume of the fluid storage unit 20 storing the fluid. The fuel cell system uses this fluid supply container 1.

### BACKGROUND

1. Technical Field

The present invention relates to a fluid supply container for supplying a fluid to a fluid acceptor, and to a fuel cell system using this fluid supply container.

2. Related Art

Liquid supply containers for easily and securely supplying liquid to liquid acceptors have been in general use, as represented by fuel cartridges for supplying liquid fuel to fuel cells, or ink cartridges for supplying ink to ink injection heads in ink-jet printers.

This type of liquid supply container normally has a pressurizing mechanism for pressurizing a liquid stored in the liquid supply container in order to efficiently supply the liquid to a liquid acceptor. As this liquid pressurizing mechanism, a mechanism for sending the liquid from the liquid supply container to the liquid acceptor by using a force-applying member like a spring to move a partition to apply pressure on the liquid is widely used.

For example, there is a fuel container (or liquid supply container) for a fuel cell mechanism, that includes a means for changing the volume of a fuel chamber according to the internal pressure of the fuel chamber, wherein the means is configured to generate the required pressure to push fuel out of the fuel chamber without using a pump, in order to supply the fuel to a fuel consuming mechanism (see JP-A-2000-314376).

There is also a fuel supply source (or liquid supply container) for a fuel cell), that includes: a fuel storage area; a fuel solution outlet configured to discharge a fuel solution from the fuel storage area; a waste storage area; a waste inlet configured to receive waste into the waste storage area; and a movable barrier for separating the fuel storage area from the waste storage area, wherein the movable barrier is moved when the fuel solution is sent from the fuel storage area and the waste is received by the waste storage area, so that the volume of the fuel storage area decreases and the volume of the waste storage area increases (see JP-A-2003-142135).

Furthermore, there is a liquid cartridge (or liquid supply container) that can discharge a liquid in any upward or downward direction. The liquid cartridge includes: a partition member for dividing a casing into a first chamber connected to an outlet formed on the casing, and a second chamber unconnected to the outlet; and a means for pressurizing, via the partition member, fuel stored in the first chamber (see JP-A-2004-142831).

However, in the conventional liquid supply containers having the pressurizing mechanisms described above, friction is produced between a partition plate and a housing for supporting the partition plate when the partition plate is moved. Since there is a large difference between static friction generated when the partition member starts moving, and dynamic friction generated when the partition member is moving, it is difficult to apply pressure on the liquid continuously and uniformly. Accordingly, it is difficult to control the supply of the liquid to the liquid acceptor. Therefore, it is necessary to control the pressure applied to the liquid by, for example, providing a regulator or similar. Also, there is a possibility of leakage from gaps caused by sliding movements of the partition plate against the housing.

Furthermore, regarding the liquid supply containers described in JP-A-2000-314376, JP-A-2003-142135, and JP-A-2004-142831, it is desirable that the amount of liquid left in the liquid supply containers after supplying the stored liquid to the liquid acceptor should be made as little as possible and the supply rate of the liquid to the liquid acceptor be enhanced.

### SUMMARY

The present invention was devised in light of the circumstances described above. It is an object of the invention to provide a fluid supply container that can apply uniform pressure on a fluid stored in the fluid supply container and enhance the supply rate of the fluid to a fluid acceptor, and to provide a fuel cell system that uses this fluid supply container.

According to an aspect of the invention, in order to achieve the object described above, a fluid supply container including a fluid storage unit and a pressurizing mechanism for pressurizing the fluid storage unit and supplying a fluid stored in the fluid storage unit to a fluid acceptor is provided. The fluid storage unit includes a first storage chamber, and a second storage chamber defined by a flexible member and connected to the first storage chamber so as to allow the fluid to flow to/from the first storage chamber, and the flexible member is reversed by means of pressurization by the pressurizing mechanism so that the flexible member enters the first storage chamber, thereby reducing the volume of the fluid storage unit storing the fluid.

A fluid supply container having the above-described structure can supply the fluid stored in the fluid storage unit to the fluid acceptor when the flexible member that defines the second storage chamber is reversed by means of pressurization by the pressurizing mechanism so that the flexible member enters the first storage chamber, thereby reducing the volume of the fluid storage unit storing the fluid. Accordingly, when the action to supply the fluid to the fluid acceptor is performed, discontinuous application of pressure to the fluid due to static friction and dynamic friction, as observed in conventional fluid supply containers, does not occur, and pressure can be applied to the fluid continuously and uniformly according to volume changes. Therefore, it is easy to control the fluid supply.

Since the flexible member that defines the second storage chamber is reversed in such a way that the flexible member enters the first storage chamber, when the flexible member is completely reversed, the second storage chamber is put in the first storage chamber in a reversed state. Accordingly, the volume of the fluid stored in the fluid storage unit can be decreased efficiently and almost the all of the fluid can be discharged. Therefore, the supply rate of the fluid to the fluid acceptor can be enhanced.

The fluid supply container in accordance with an embodiment of the invention can further include a case for enclosing the fluid storage unit and the pressurizing mechanism and be configured so that the first storage chamber is defined by the inner wall of the case. In addition to the advantageous effects described above, this structure can achieve size reduction of the fluid supply container.

Moreover, the fluid supply container in accordance with an embodiment of the invention can be structured so that a space is formed between the flexible member and the inner wall of the case when the flexible member is reversed. Because of this structure, it is possible to prevent the flexible member from coming into contact with the inner wall of the case when the flexible member is reversed, and it is also possible to prevent the generation of friction between the flexible member and the inner wall of the case.

The pressurizing mechanism can further include a force-applying member. Consequently, the force-applying member can cause the flexible member to be reversed from its original position more efficiently so that the flexible member enters the first storage chamber.

The pressurizing mechanism can include a support plate on the end face of the second storage chamber opposite its end face adjacent to the first storage chamber. Because of this structure, the flexible member can be reversed from its original position more efficiently so that the flexible member enters the first storage chamber.

The force-applying member can be placed between the support plate and the inner wall facing the support plate of the case that contains the fluid storage unit and the pressurizing mechanism, and the force-applying member can contract and press tightly against the support plate and the inner wall. Because of this structure, in addition to the advantageous effects described above, the force-applying member can be placed in a much narrower space. Accordingly, a large ratio of the volume of the fluid storage unit to the volume of the entire fluid supply container can be ensured and the size of the fluid supply container can be further reduced.

Examples of the force-applying member include a conical coil spring, a hourglass-shaped spring, and a volute spring. When such springs are compressed (i.e., when the adjacent coils are brought closer to each other), the adjacent coils do not interfere with each other. Therefore, the length of the spring along its expansion/contraction direction can be made minimal and the spring can be placed in a narrow space.

The support plate can be structured so that a space for accommodating a folded part of the reversed flexible member can be formed between the support plate and the inner wall of the case that contains the fluid storage unit and the pressurizing mechanism. This structure can cause the flexible member to be reversed more smoothly.

Furthermore, the fluid supply container according to an embodiment of the invention can be structured so that when the flexible member is completely reversed, the end face of the second storage chamber opposite its end face adjacent to the first storage chamber can come into contact with the end face of the first storage chamber opposite its end face adjacent to the second storage chamber. Accordingly, when the flexible member is completely reversed, the volume of the fluid stored in the fluid storage unit can be decreased efficiently. Therefore, the supply rate of the fluid to the fluid acceptor can be further enhanced.

The first storage chamber and the second storage chamber may be formed so that their respective lengths along their aligned sides are almost the same. Also, the length of the second storage chamber along the aligned sides may be made slightly shorter than that of the first storage chamber, and the flexible member which constitutes the second storage chamber may be elastically extended so that the first storage chamber and the second storage chamber can be in contact with each other.

There are no particular limitations on material used for the flexible member, as long as it can be reversed by means of pressurization by the pressurizing mechanism so that the flexible member enters the first storage chamber and the volume of the fluid storage unit storing the fluid can be reduced. Examples of the flexible member include ones made from rubber, resins, or members made by laminating rubber and/or resins. These materials can be selected as appropriate in consideration of their chemical resistance properties with respect to the fluid stored in the fluid storage unit.

According to another aspect of the invention, a fuel cell system including a fuel cell and the fluid supply container described above is provided. This fuel cell system supplies a fluid contained in the fluid supply container to the fuel cell. Since the fuel cell system includes the fluid supply container having the aforementioned advantageous effects, it can stably and efficiently supply the fluid to the fuel cell.

Also, if the fluid contains methanol in the fuel cell system in accordance with an embodiment of the invention, the flexible member can include a film made of EPDM (Ethylene Propylene Diene Methylene Linkage). EPDM is formed by so-called “rubber-ethylene-propylene-diene terpolymer” obtained by polymerizing ethylene, propylene, and butadiene. EPDM is also called “ethylene-propylene rubber” and is synthetic rubber that exhibits superior aging resistance, chemical resistance, ozone resistance, low-temperature resistance, and heat stability. EPDM is widely used for, for example, various vehicle components for mainly automobiles, belts, gaskets, electric wires, waterproof materials, polyolefin impact strength modifiers (bumpers), packing for colored pavement iron covers, cushion materials for gratings, and surface layer materials for recycled rubber chip pavement materials.

Furthermore, besides the liquid fuel containing methanol, for example, a gas containing hydrogen and/or other components may be employed as the aforementioned fluid.

The fluid supply container according to an aspect of the invention is structured so that the fluid stored in the fluid storage unit is supplied to the fluid acceptor when the flexible member that defines the second storage chamber is reversed by means of pressurization by the pressurizing mechanism so that the flexible member enters the first storage chamber and the volume of the fluid storage unit storing the fluid is reduced. Accordingly, pressure can be applied to the fluid continuously and it is easy to control the fluid supply. Also, when the flexible member is completely reversed, the second storage chamber is put in the first storage chamber in a reverse state. Accordingly, the volume of the fluid stored in the fluid storage unit can be decreased efficiently and almost all of the fluid can be discharged. As a result, the supply rate of the fluid to the fluid acceptor can be enhanced.

Furthermore, since the fuel cell system according to an aspect of the invention has a fluid supply container according to an aspect of the invention, it can stably and efficiently supply the fluid to the fuel cell.

### BRIEF DESCRIPTION OF THE DRAWINGS

FIG. 1 is a side view of a fluid supply container according the first embodiment of the invention.

FIG. 2 is a cross-sectional view of the fluid supply container as taken along line II-II in FIG. 1, showing the state where a fluid storage unit of the fluid supply container is filled with a liquid.

FIG. 3 is a cross-sectional view of the fluid supply container as taken along line II-II in FIG. 1, showing the process of discharging the liquid stored in the fluid storage unit of the fluid supply container.

FIG. 4 is a cross-sectional view of the fluid supply container as taken along line II-II in FIG. 1, showing the process of discharging the liquid stored in the fluid storage unit of the fluid supply container.

FIG. 5 is a cross-sectional view of the fluid supply container as taken along line II-II in FIG. 1, showing the state where the liquid stored in the fluid storage unit of the fluid supply container has been completely discharged.

FIG. 6 is a side view of a fluid supply container according to the second embodiment of the invention.

FIG. 7 is a cross-sectional view of the fluid supply container as taken along line VII-VII in FIG. 6, showing the state where a fluid storage unit of the fluid supply container is filled with a liquid.

FIG. 8 is a cross-sectional view of the fluid supply container as taken along line VII-VII in FIG. 6, showing the state where the liquid stored in the fluid storage unit of the fluid supply container has been completely discharged.

FIG. 9 is a schematic diagram of a fuel cell system according to the first embodiment of the invention.

### DETAILED DESCRIPTION OF PREFERRED EMBODIMENTS

A fluid supply container and a fuel cell system using the fluid supply container according to preferred embodiments of the invention will be described below with reference to the attached drawings. The embodiments described below are for the purpose of describing this invention, but the invention is not limited only to those embodiments. Accordingly, this invention can be utilized in various ways unless those utilizations depart from the gist of the invention.

### First Embodiment

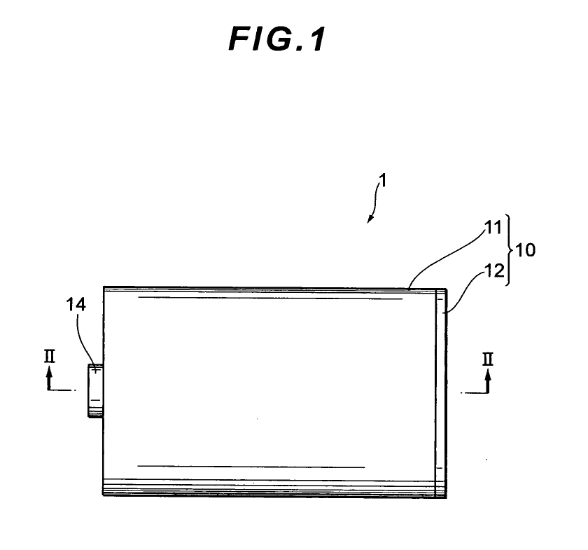

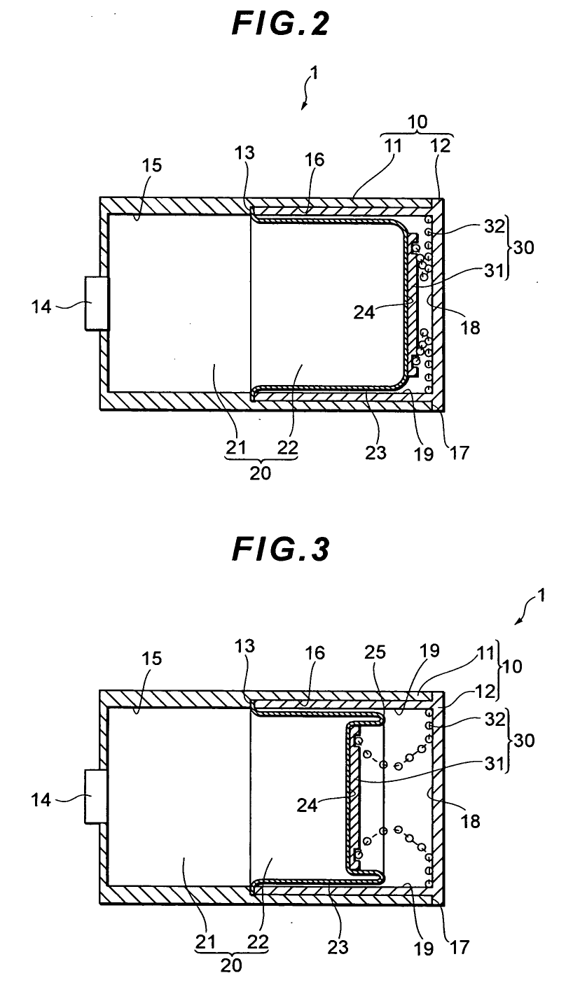

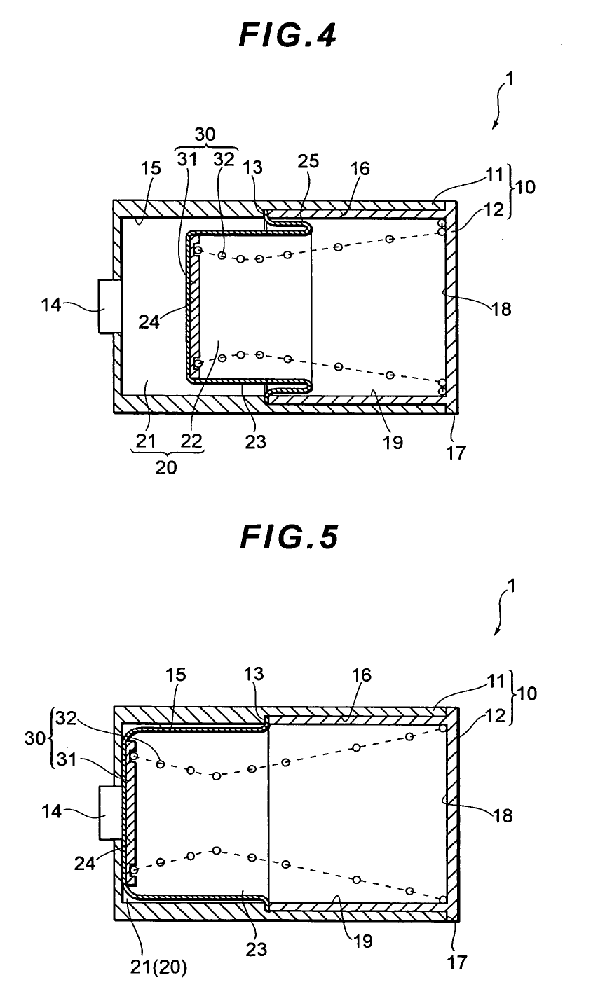

FIG. 1 is a side view of a fluid supply container according the first embodiment of the invention. FIG. 2 is a cross-sectional view of the fluid supply container as taken along line II-II in FIG. 1, showing the state where the fluid storage unit of the fluid supply container is filled with a liquid. FIGS. 3 and 4 are cross-sectional views of the fluid supply container as taken along line II-II in FIG. 1, showing the process of discharge of the liquid stored in the fluid storage unit of the fluid supply container. FIG. 5 is a cross-sectional view of the fluid supply container as taken along line II-II in FIG. 1, showing the state where the liquid stored in the fluid storage unit of the fluid supply container has been completely discharged.

In the first embodiment, a case where a liquid is used as the fluid will be described. For convenience of explanation, one side of the fluid supply container from which the fluid (or liquid) is discharged (i.e., the left side in FIG. 1) is referred to as the “top end,” while the opposite side of the fluid supply container (i.e., the right side in FIG. 1) is referred to as the “base end.”

As shown in FIGS. 1 to 5, a fluid supply container 1 according to the first embodiment includes: a case 10; a fluid storage unit 20 contained in the case 10; and a pressurizing mechanism 30 contained in the case 10 for pressurizing the fluid storage unit 20.

The case 10 is composed of: a hollow case body 11 that has a generally cylindrical shape; and a cover 12 placed at the base end of the case body 11. The wall thickness of the case body 11 in the area from a generally central part of the case body 11 in its lengthwise direction to the top end side is thicker than the area from the same generally central part of the case body 11 in its lengthwise direction to the base end side. Consequently, a stepped part 13 is formed around the inner surface of the case body 11 in its generally central part in the lengthwise direction.

On the top end face of the case body 11, a discharge port 14 that is connected to the fluid storage unit 20 to allow the liquid to pass through, and that discharges the liquid stored in the fluid storage unit 20 is placed. This discharge port 14 can be connected to a fluid inlet of the fluid acceptor to which the liquid stored in the fluid storage unit 20 is supplied.

The cover 12 has a generally U-shaped cross-section and its top end extends almost to the stepped part 13 of the case body 11. In other words, the cover 12 is placed in close contact with base end face 17 of the case body 11 and a thin part of an inner wall 16 of the case body 11.

The fluid storage unit 20 is composed of: a first storage chamber 21; and a second storage chamber 22 defined by a flexible member 23 and connected to the first storage chamber 21 so as to allow the fluid to flow to/from the first storage chamber 21. The first storage chamber 21 is defined by a thick part of the inner wall 16 of the case body 11.

The second storage chamber 22 is defined by the flexible member 23 that is formed in a generally cylindrical bag shape extending from the step part 13 of the case body 11 toward the base end side. The open end of this flexible member 23 is placed inside the case body 11 in the state where it is held between the stepped part 13 and the top end of the cover 12. There is a space between the flexible member 23 and the inner wall 19 of the cover 12 as described later. The flexible member 23 is held between the stepped part 13 and the cover 12, and serves to seal the case body 11 and the cover 12.

This flexible member 23 is reversed and caused to enter the first storage chamber 21 by means of pressurization by the pressurizing mechanism 30 described later in detail (see FIGS. 3 to 5) and can thereby reduce the volume of the fluid storage unit 20 storing the fluid. In the first embodiment, a film made of EPDM is used as the flexible member 23.

The pressurizing mechanism 30 is placed between the bottom face 18 of the cover 12 and the base end face 24 of the flexible member 23. This pressurizing mechanism 30 includes: a support plate 31 placed at the base end face 24 of the flexible member 23; and an hourglass-shaped spring 32 whose one end is secured to the support plate 31 and whose the other end is secured to the bottom face 18 of the cover 12. This hourglass-shaped spring 32 presses tightly against the support plate 31 and the bottom face 18 and expands and contracts. In other words, since the adjacent coils do not interfere with each other, even if the fluid storage unit 20 is filled with a liquid as shown in FIG. 2, the hourglass-shaped spring 32 can be put in a remaining narrow space. Accordingly, if the volume of the fluid storage unit 20 is compared with the volume of a space for the pressurizing mechanism 30 in the volume of the entire fluid supply container 1, a large ratio of the volume of the fluid storage unit 20 to that of the pressurizing mechanism 30 can be secured, and the size reduction of the fluid supply container 1 can be achieved.

The support plate 31 is made of a disk member whose diameter is slightly less than that of the base end face 24 of the flexible member 23, so that a space for accommodating the folded part 25 of the reversed flexible member 23 (see FIGS. 3 and 4) can be formed between the support plate 31 and the inner wall 19 of the cover 12.

Specific operation of the fluid supply container 1 according to the first embodiment will be described below with reference to the relevant drawings.

When the fluid storage unit 20 of the fluid supply container 1 is filled with a liquid as shown in FIG. 2, the flexible member 23 extends close to the base end side of the case body 11 and the second storage chamber 22 then has the maximum volume. At this moment, the liquid pressure of the liquid stored in the fluid storage unit 20 is stronger than the force applied by the hourglass-shaped spring 32, and the hourglass-shaped spring 32 presses tightly against the support plate 31 and the bottom face 18 and is made to contract. When the discharge port 14 is connected to a fluid inlet of a fluid acceptor (not shown in the drawings) (a liquid acceptor such as a fuel cell or an ink-jet printer), this fluid supply container 1 supplies the liquid to the fluid acceptor.

When the fluid supply container 1 starts supplying the liquid to the connected fluid acceptor, the amount of liquid stored in the fluid storage unit 20 gradually decreases. As a result, the hourglass-shaped spring 32 presses the flexible member 23 via the support plate 31, and the flexible member 23 is reversed from its original position as shown in FIG. 3 and FIG. 4, and the base end face 24 moves toward the first storage chamber 21, thereby reducing the volume of the second storage chamber 22.

Since a small space is formed between the inner wall 19 of the cover 12 and the flexible member 23, when the flexible member 23 is reversed from its original position, it is possible to prevent the flexible member 23 from coming into contact with the inner wall 19 of the cover 12. As a result, it is possible to prevent any adverse effects that may be caused by friction between the flexible member 23 and the inner wall 19. Moreover, since a small space is also formed between the flexible member 23 and the inner wall 15 of the first storage chamber 21, when the flexible member 23 is reversed from its original position, it is possible to prevent the generation of friction between the flexible member 23 and the inner wall 15. As a result, pressure can be continuously applied to the liquid when supplying the liquid to the fluid acceptor, and it is easy to control the liquid supply.

After the fluid supply container 1 supplies more liquid, the flexible member 23 is completely reversed as shown in FIG. 5 and occupies almost the entire area of the first storage chamber 21, and the base end face 24 of the flexible member 23 comes into contact with the top end face of the first storage chamber 21. Accordingly, there is almost no volume left for the liquid to remain in the first storage chamber 21 and almost all of the liquid stored in the fluid storage unit 20 can be supplied to the fluid acceptor. As a result, the supply rate of the liquid to the liquid acceptor can be enhanced.

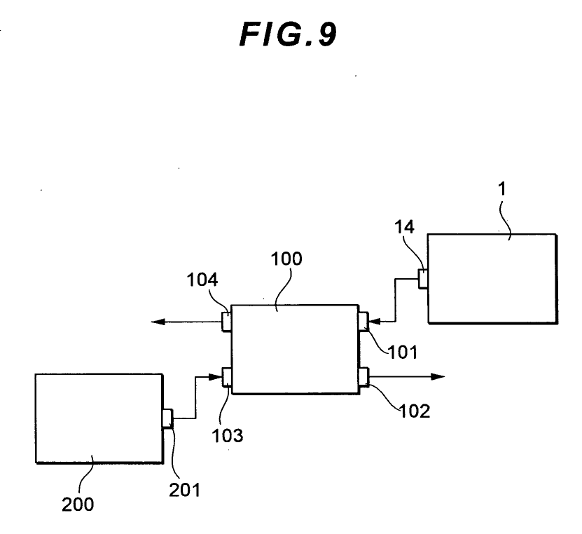

Next, the case where the fluid supply container 1 according to the first embodiment is applied to a fuel cell will be explained with reference to FIG. 9. FIG. 9 is a schematic diagram of a fuel cell system according to the first embodiment of the invention.

The fuel cell system according to the first embodiment includes: a fuel cell 100; the fluid supply container 1 connected to a fluid supply inlet 101 for supplying fuel (liquid fuel in the first embodiment) to a fuel electrode of the fuel cell 100; and an oxygen gas supply source 200 connected to an air supply inlet 103 for supplying oxygen gas (normally, air) to an air electrode of the fuel cell 100. The reference numeral “102” indicates an off-gas exhaust port for discharging an off-gas (or exhaust gas) from the fuel electrode of the fuel cell 100. The reference numeral “104” indicates an off-gas exhaust port for discharging an off-gas from the air electrode of the fuel cell 100. The reference numeral “201” indicates an oxygen gas discharge port for the oxygen gas supply source 200.

In FIG. 9, the discharge port 14 of the fluid supply container 1 is connected to a fuel inlet 101 with an arrow for ease of explanation. However, the discharge port 14 may be directly connected to the fuel inlet 101 via a connecting member such as a pipe or a tube. The same can be said for the oxygen gas discharge port 201 and the oxygen gas inlet 103. The oxygen gas supply source 200 may be, for example, a container like a tank that stores oxygen gas. Alternatively, oxygen may be supplied directly from the atmosphere to the fuel cell 100.

Various types of fuel cells can be used as the fuel cell 100. In the first embodiment, a DMFC (Direct Methanol Fuel Cell) is used, and methanol is stored as the liquid fuel for the fuel cell 100 in the fluid storage unit 20 of the fluid supply container 1.

In the fuel cell system having the above-described structure, the liquid fuel is supplied by the fluid supply container 1 according to the first embodiment. Therefore, pressure can be continuously applied to the liquid fuel when supplying the liquid fuel and it is easy to control the liquid supply. Also, the supply rate of the liquid fuel to the fuel cell 100 can be enhanced.

The first embodiment has described the case where the hourglass-shaped spring 32 is used as a component of the pressurizing mechanism 30. However, other types of springs such as a conical coil spring or a volute spring that presses tightly against the support plate 31 and the bottom face 18 and contracts, i.e., whose adjacent coils do not interfere with each other can be used with favorable results. Also, the pressurizing mechanism 30 is not limited to the type described above, and a pressurizing mechanism having another structure may be applied, as long as it can pressurize and reverse the flexible member 23 to make the flexible member 23 enter the first storage chamber 21, thereby reducing the volume of the fluid storage unit 20 storing the fluid.

The first embodiment has described the case where the case 10 has a generally cylindrical shape. However, the shape of the case 10 is not limited to a generally cylindrical shape, and it is possible to decide the shape and size of the case 10 as desired, according to, for example, the conditions for the liquid acceptor.

Furthermore, the first embodiment has described the case where the liquid is used as the fluid and stored in the fluid storage unit 20. However, the fluid is not limited to a liquid, and there is no particular limitation to the type of fluid stored in the fluid storage unit 20 as long as the fluid, such as a gas or a sol like a milky liquid, can flow and be discharged from the fluid supply container 1.

### Second Embodiment

Next, a fluid supply container according to the second embodiment of the invention will be described with reference to the relevant drawings.

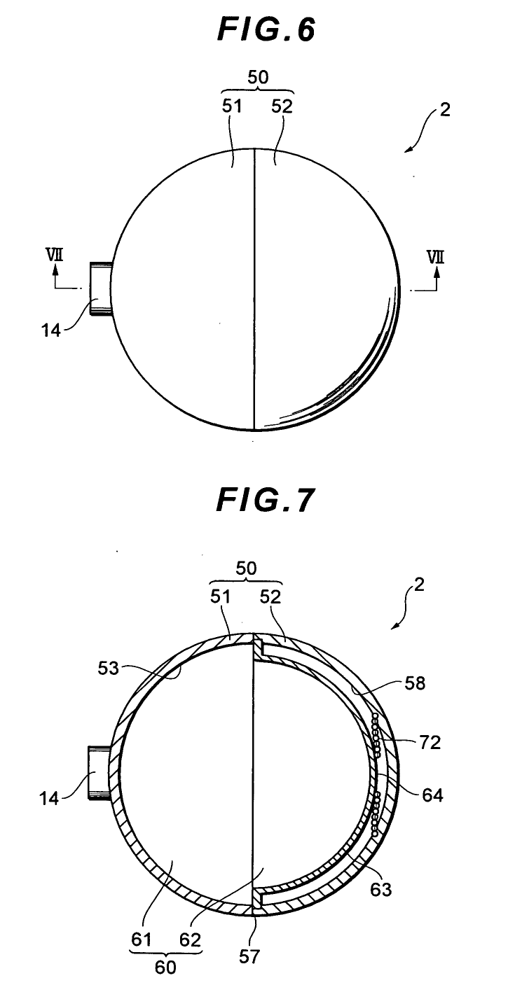

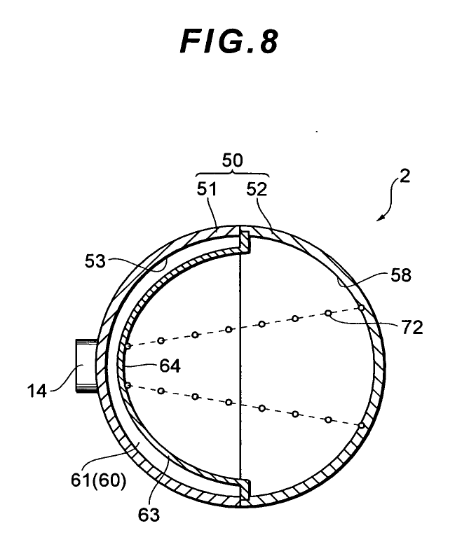

FIG. 6 is a side view of a fluid supply container according to the second embodiment of the invention. FIG. 7 is a cross-sectional view of the fluid supply container as taken along line VII-VII in FIG. 6, showing the state where a fluid storage unit of the fluid supply container is filled with a liquid. FIG. 8 is a cross-sectional view of the fluid supply container as taken along line VII-VII in FIG. 6, showing the state where the liquid stored in the fluid storage unit of the fluid supply container has been completely discharged.

As shown in FIGS. 6 to 8, a fluid supply container 2 according to the second embodiment includes: a case 50; a fluid storage unit 60 contained in the case 50; and a pressurizing mechanism 72 that is contained in the case 50 and pressurizes the fluid storage unit 60.

The case 50 includes: a hollow case body 51 that has a generally hemispherical shape; and a hollow cover 52 that is placed on the base end side of the case body 51 and has a generally hemispherical shape. The case 50 of a generally spherical shape is formed by combining (or connecting) the case body 51 and the cover 52.

A discharge port 14, similar to that of the first embodiment, that is connected to the fluid storage unit 60 and used to discharge a liquid stored in the fluid storage unit 60 is placed on the top end face of the case body 51. A groove 57 for fixing the open top end of a flexible member 63 described later in detail is formed around the inside surface of the cover 52 at its open top end.

The fluid storage unit 60 includes: a first storage chamber 61; and a second storage chamber 62 defined by a flexible member 63 and connected to the first storage chamber 61 so as to allow a fluid to flow to/from the first storage chamber 61. The flexible member 63 has a generally hemispherical bag shape that extends from the groove 57 in the cover 52 toward the base end side. The flexible member 63 is placed within the case 50 in the state where the open top end of the flexible member 63 is placed in and fixed to the groove 57. There is a space between the flexible member 63 and the inner wall 58 of the cover 52, and the flexible member 63 is placed in the groove 57, so that the flexible member 63 can seal the case body 51 and the cover 52.

This flexible member 63, similar to the flexible member 23 described in the first embodiment, is reversed by means of pressurization by the pressurizing mechanism 72 so that the flexible member 63 enters the first storage chamber 61, thereby reducing the volume of the fluid storage unit 60 storing the fluid.

The pressurizing mechanism 72 is composed of an hourglass-shaped spring whose one end is fixed to the approximate top area of the inner wall 58 of the cover 52 and whose the other end is fixed to the approximate top area 64 of the flexible member 63. The pressurizing mechanism 72 contributes to the size reduction of the fluid supply container 2 in the same manner as in the first embodiment.

Next, the specific operation of the fluid supply container 2 according to the second embodiment will be described below with reference to the relevant drawings.

When the fluid storage unit 60 of the fluid supply container 2 is filled with a liquid as shown in FIG. 7, the flexible member 63 extends close to the base end side of the cover 52 and the second storage chamber 62 then has the maximum volume in the same manner as in the first embodiment.

When the fluid supply container 2 starts supplying the liquid to the fluid acceptor connected to the fluid supply container 2, the pressurizing mechanism 72 presses the flexible member 63 and the amount of liquid stored in the fluid storage unit 60 gradually decreases. Then, the flexible member 63 is reversed from its original position. After the fluid supply container 2 supplies more liquid to the fluid acceptor, the flexible member 63 is completely reversed as shown in FIG. 8. Here, as in the first embodiment, pressure can be continuously applied to the liquid when supplying the liquid to the fluid acceptor, it is easy to control the liquid supply, and the supply rate of the liquid to the liquid acceptor can be enhanced.

In the fluid supply container 2 according to the second embodiment, it is unnecessary to provide the support plate used in the first embodiment. As a result, the structure can be further simplified.

Furthermore, like in the first embodiment, other types of spring such as a conical coil spring or a volute spring, whose adjacent coils do not interfere with each other, can be used favorably instead of the hourglass-shaped spring as the pressurizing mechanism 72. Also, a pressurizing mechanism having another structure may be applied.

What is claimed is:

1. A fluid supply container comprising:
a fluid storage unit; and
a pressurizing mechanism for pressurizing the fluid storage unit;
wherein a fluid stored in the fluid storage unit is supplied to a fluid acceptor,
wherein the fluid storage unit includes a first storage chamber, and a second storage chamber defined by a flexible member and connected to the first storage chamber so as to allow the fluid to flow to/from the first storage chamber, and
wherein the flexible member is reversed by means of pressurization by the pressurizing mechanism so that the flexible member enters the first storage chamber, thereby reducing the volume of the fluid storage unit storing the fluid.

2. The fluid supply container according to claim 1, further comprising a case for enclosing the fluid storage unit and the pressurizing mechanism,
wherein the first storage chamber is defined by an inner wall of the case.

3. The fluid supply container according to claim 2, wherein a space is formed between the flexible member and the inner wall of the case when the flexible member is reversed.

4. The fluid supply container according to claim 1, wherein the pressurizing mechanism includes a force-applying member.

5. The fluid supply container according to claim 1, wherein the pressurizing mechanism includes a support plate on the end face of the second storage chamber opposite its end face adjacent to the first storage chamber.

6. The fluid supply container according to claim 5, wherein the force-applying member is placed between the support plate and the inner wall facing the support plate of the case that contains the fluid storage unit and the pressurizing mechanism, and the force-applying member can contract and press tightly against the support plate and the inner wall.

7. The fluid supply container according to claim 4, wherein the force-applying member is a conical coil spring, an hourglass-shaped spring, or a volute spring.

8. The fluid supply container according to claim 5, wherein the support plate can form a space for accommodating a folded part of the reversed flexible member between the support plate and the inner wall of the case that contains the fluid storage unit and the pressurizing mechanism.

9. The fluid supply container according to claim 1, wherein when the flexible member is completely reversed, the end face of the second storage chamber opposite its end face adjacent to the first storage chamber can come into contact with the end face of the first storage chamber opposite its end face adjacent to the second storage chamber.

10. A fuel cell system comprising:
a fuel cell; and
the fluid supply container described in any one of claims 1 to 9;
wherein the fuel cell system supplies a fluid contained in the fluid supply container to the fuel cell.

11. The fuel cell system according to claim 10, wherein the fluid contains methanol and the flexible member includes a film made of EPDM.
